(19) United States
(12) Patent Application Publication
(10) Pub. No.: US 2025/0058988 A1
(43) Pub. Date: Feb. 20, 2025

(54) SILENT ONE-WAY CLUTCH ASSEMBLY AND DOCUMENT SCANNER USING THE SAME

(71) Applicant: AVISION INC., Hsinchu (TW)

(72) Inventor: CHIEN CHIA CHIU, Chiayi City (TW)

(21) Appl. No.: 18/787,583

(22) Filed: Jul. 29, 2024

(30) Foreign Application Priority Data
Aug. 17, 2023 (TW) 112130920

(51) Int. Cl. B65H 3/06; B65H 5/06

(52) U.S. Cl. CPC B65H 3/0669; B65H 5/062; B65H 2403/72

(57) ABSTRACT

A silent one-way clutch assembly includes: a first shaft and a second shaft; a gear mounted on a first end of the first shaft; and a ratchet coupling the first shaft to the second shaft in a unidirectional driving manner, so that the gear drives the second shaft to rotate through the first shaft and the ratchet, and stops the second shaft from driving the first shaft and the gear to rotate. A document scanner using the silent one-way clutch assembly is also provided.

### CROSS-REFERENCE TO RELATED APPLICATIONS

This application claims priority of No. 112130920 filed in Taiwan R.O.C. on Aug. 17, 2023 under 35 USC 119, the entire content of which is hereby incorporated by reference.

### FIELD OF THE INVENTION

This disclosure relates to a document scanner and a silent one-way clutch assembly, and more particularly to a silent one-way clutch assembly for a document scanner and the document scanner using the same.

### DESCRIPTION OF RELATED ART

In conventional scanners, fax machines and peripherals, a document scanner feeds documents from a supply tray into a machine in order, and then the machine scans the documents to generate image signals in order. Because a feeding gap needs to be formed between the adjacent documents, the document scanner in the machine needs to be equipped with a one-way clutch assembly, so that the feeding gap is formed between the adjacent first document and second document, and multiple pages of the image signals corresponding to the separate pages are generated.

FIG. 1 is a schematic view showing a conventional one-way clutch assembly 300. Referring to FIG. 1, the one-way clutch assembly 300 has the structure and usage similar to those of U.S. Pat. No. 5,116,038, associated details can be understood therefrom, and detailed descriptions thereof will be omitted. The one-way clutch assembly 300 includes a rotating shaft 310, a connection bushing 320, a torsion spring 330 and a gear 340. The torsion spring 330 is fit with and connected to one end of the connection bushing 320 and one end of the gear 340. A first end 311 of the rotating shaft 310 passes through the connection bushing 320, the torsion spring 330 and the gear 340 in order. A second end 312 of the rotating shaft 310 is connected to a transporting roller (not shown) for transporting the document. The gear 340 is driven to rotate and thus drives the rotating shaft 310 to rotate unidirectionally through the torsion spring 330 and the connection bushing 320. That is, when the gear 340 is rotating, the rotating shaft 310 and the transporting roller can be driven to rotate and transport the document; and when the document drives the transporting roller and the rotating shaft 310 to rotate, the gear 340 cannot be driven to rotate. With such the design, a feeding gap (sheet-separation gap) can be formed between adjacent two documents.

However, when the mechanism of the above-mentioned design is operating, the torsion spring 330 rubs against the connection bushing 320 to cause abnormal noise and shorten the service lifetime of the overall one-way clutch assembly 300. In addition, the gradual frictional wear makes the document transportation become less stable, so that the document scan quality is gradually affected, and higher requirements of the users on the image quality cannot be satisfied. Furthermore, the vibration generated by the rotating gear 340 is directly transferred to the rotating shaft 310, and also affects the scan quality.

### SUMMARY OF THE INVENTION

It is therefore an objective of this disclosure to provide a silent one-way clutch assembly and a document scanner using the same, wherein a ratchet disposed between two shafts is adopted to achieve the unidirectional power transmission between the two shafts to decrease the vibration transfer and noise.

To achieve the above-identified objective, this disclosure provides a silent one-way clutch assembly of a document scanner including: a first shaft and a second shaft; a gear mounted on a first end of the first shaft; and a ratchet coupling the first shaft to the second shaft in a unidirectional driving manner, so that the gear drives the second shaft to rotate through the first shaft and the ratchet, and stops the second shaft from driving the first shaft and the gear to rotate.

This disclosure also provides the document scanner including: a body; the one-way clutch assembly rotatably mounted on the body; a feeding roller connected to the second shaft and driven by the second shaft to rotate; a driving gear set driving the gear, a first roller and a second roller to rotate; and a scanning module disposed between the first roller and the second roller, wherein the feeding roller transports a document past the first roller, the scanning module and the second roller in order, the scanning module performs an image acquiring operation on the document passing through the scanning module.

With the above-mentioned embodiment, engineering plastic can be used to manufacture most components of the one-way clutch assembly with self-lubricating properties, so that the relative movements between these components cannot generate abnormal noise, these components can absorb vibration or cut off the vibration transfer, and the operation of the document scanner becomes quieter. In addition, the service lifetime can be effectively increased, and the cost can be effectively reduced.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a schematic view showing a conventional one-way clutch assembly.

FIG. 2 is a pictorial view showing a document scanner according to a preferred embodiment of this disclosure.

FIG. 3 is a partial rear view showing the document scanner of FIG. 2.

FIG. 4 is a partial rear view showing the document scanner of FIG. 3.

FIG. 5 is a combination view showing the one-way clutch assembly of FIG. 4.

FIG. 6 is an exploded view showing the one-way clutch assembly of FIG. 5.

FIG. 7 is a partially exploded view showing the one-way clutch assembly of FIG. 6.

FIG. 8 is a schematically cross-sectional view showing inner members of the document scanner of FIG. 2.

FIG. 9 is a schematic side view showing the document scanner of FIG. 2.

### DETAILED DESCRIPTION OF THE INVENTION

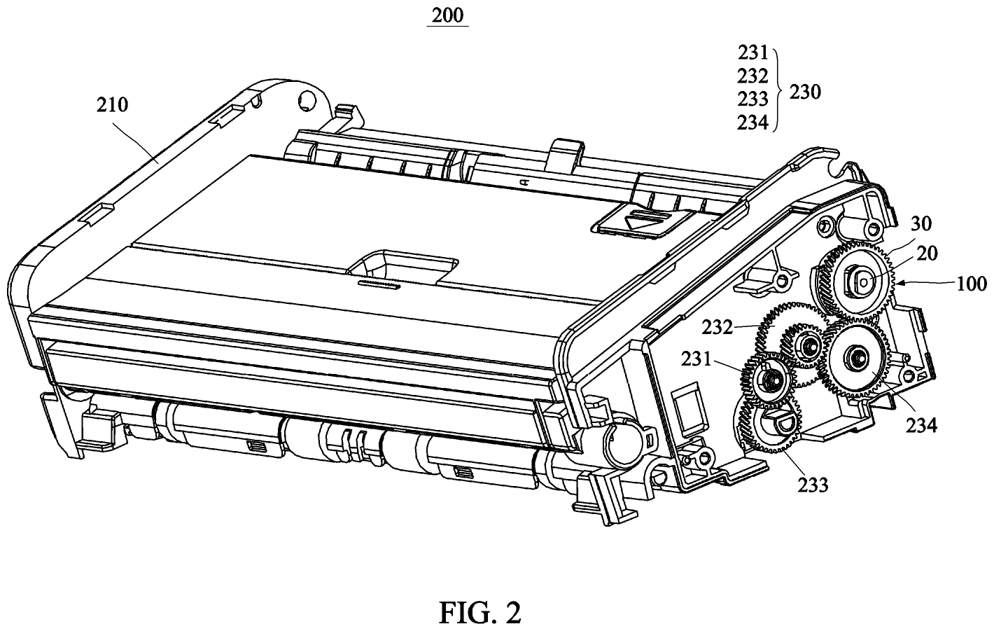

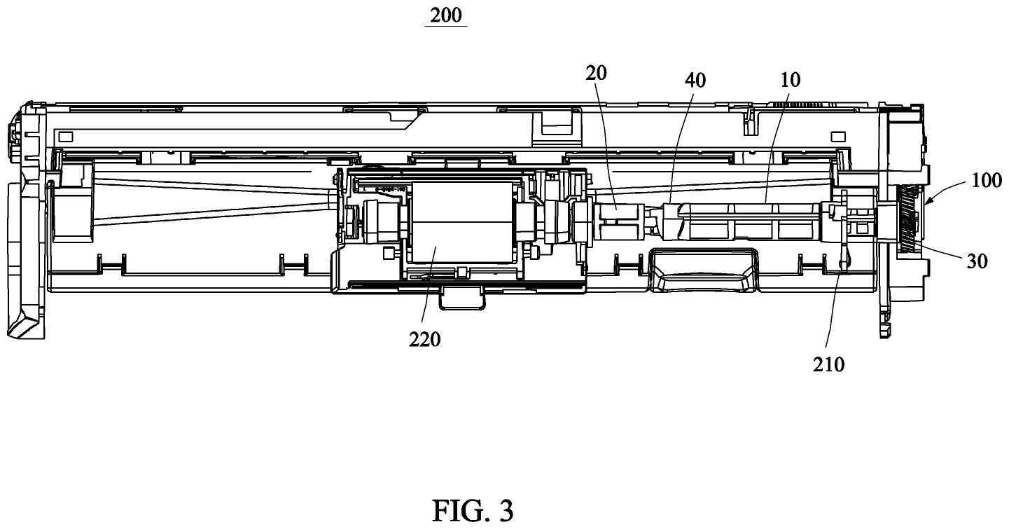

FIG. 2 is a pictorial view showing a document scanner according to the preferred embodiment of this disclosure. FIG. 3 is a partial rear view showing the document scanner of FIG. 2. Referring to FIGS. 2 and 3, a document scanner 200 includes a body 210, a one-way clutch assembly 100 and a feeding roller 220. The one-way clutch assembly 100 is rotatably mounted on the body 210, and is a silent one-way clutch assembly. The feeding roller 220 is driven by the one-way clutch assembly 100 to rotate.

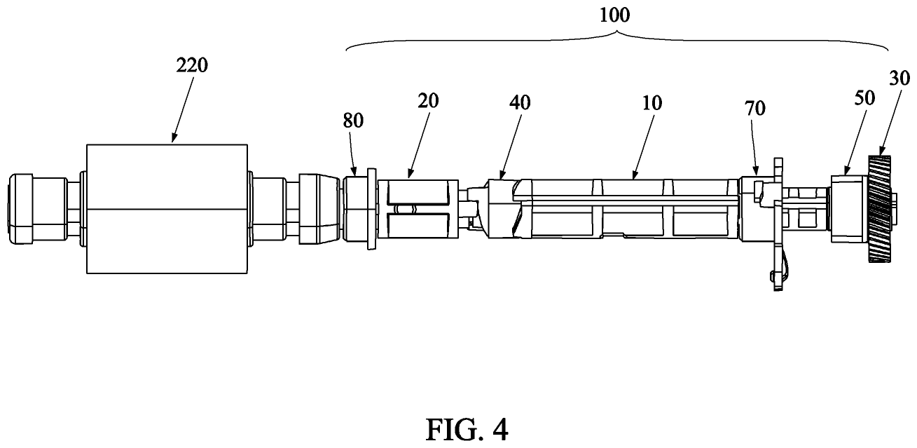

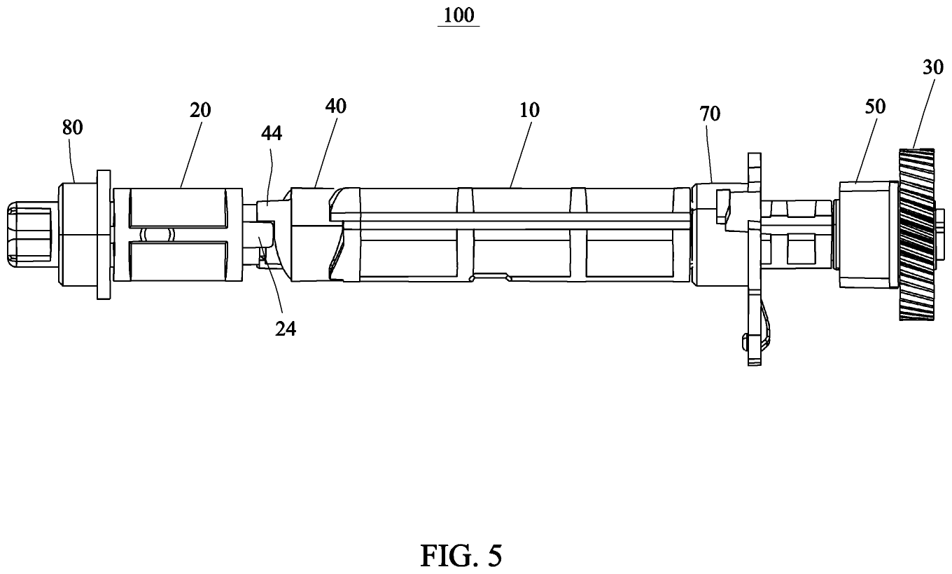

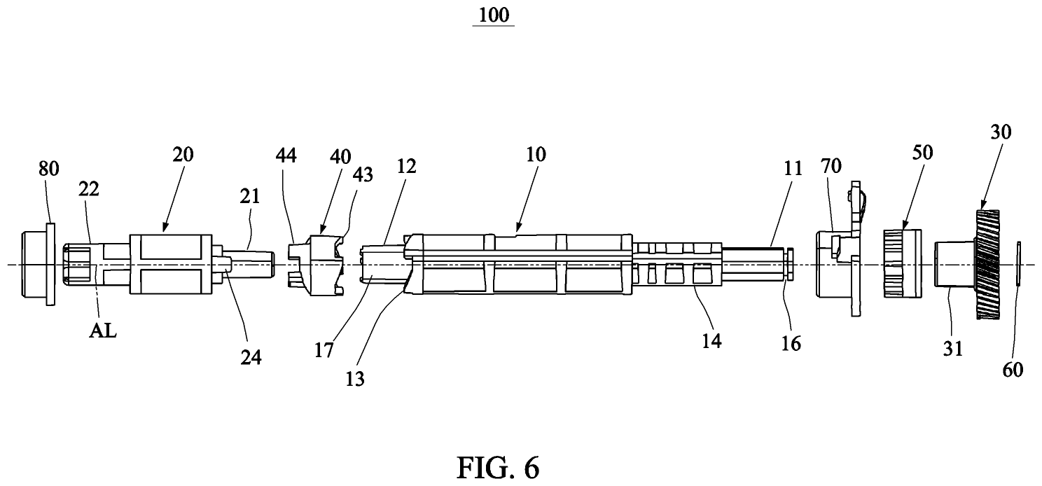

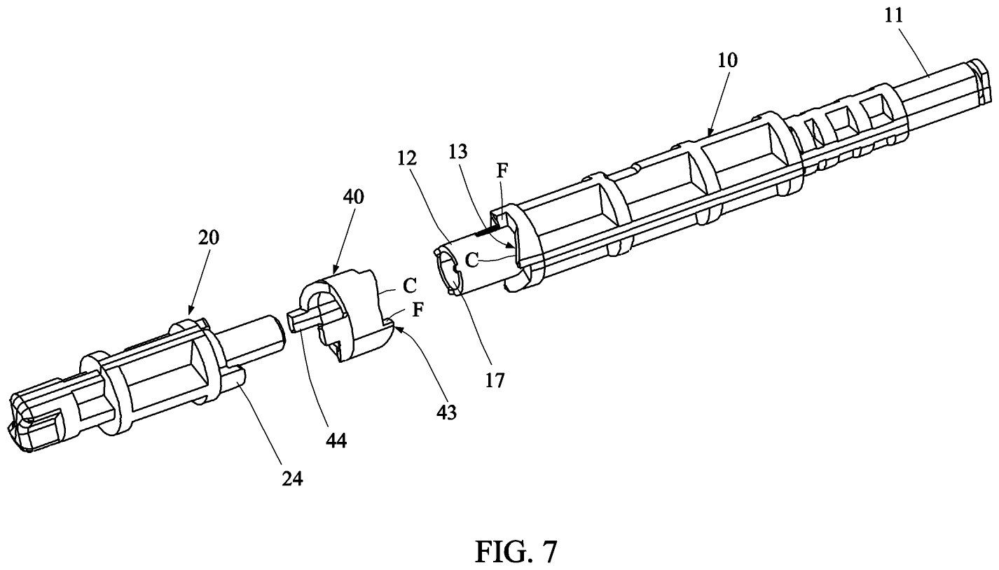

FIG. 4 is a partial rear view showing the document scanner of FIG. 3. FIG. 5 is a combination view showing the one-way clutch assembly of FIG. 4. FIG. 6 is an exploded view showing the one-way clutch assembly of FIG. 5. FIG. 7 is a partially exploded view showing the one-way clutch assembly of FIG. 6. Referring to FIGS. 2 to 7, the silent one-way clutch assembly 100 of the document scanner 200 includes a first shaft 10, a second shaft 20, a gear 30 and a ratchet 40. The first shaft 10, the second shaft 20 and the ratchet 40 are co-axially mounted, and have outer peripheral surfaces with substantially the same outer diameter, so that the members after being combined together do not occupy too much space for inventory. The gear 30 is mounted on a first end 11 of the first shaft 10. The ratchet 40 couples the first shaft 10 to the second shaft 20 in a unidirectional driving manner, so that the gear 30 drives the second shaft 20 to rotate through the first shaft 10 and the ratchet 40, and prevents or stops the power, coming from a second end 22 of the second shaft 20, from driving the first shaft 10 and the gear 30 to rotate. In one example, the first shaft 10 can drive the second shaft 20 to rotate through the ratchet 40, but the second shaft 20 cannot drive the first shaft 10 to rotate through the ratchet 40. The feeding roller 220 is connected to the second shaft 20, and is driven by the second shaft 20 to rotate.

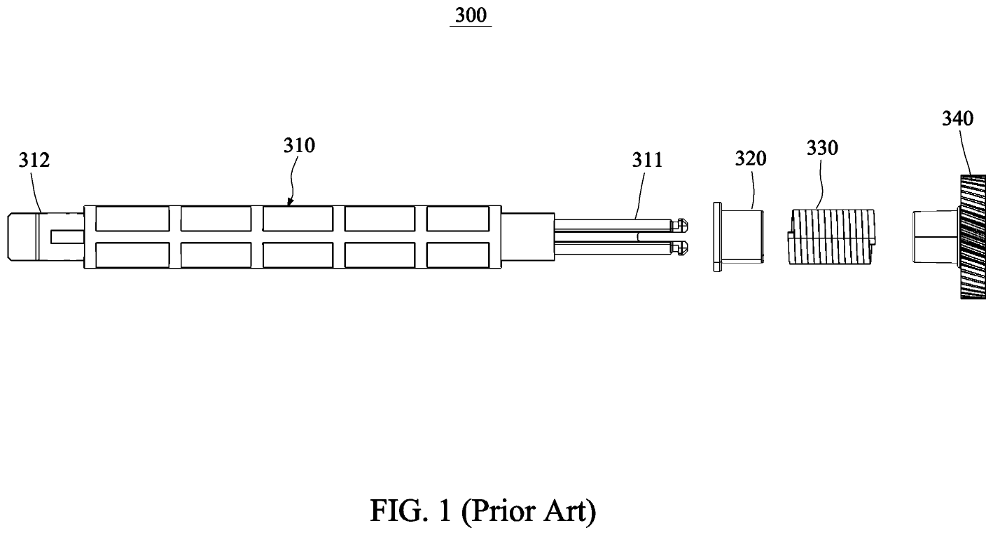

With the above-mentioned one-way clutch assembly 100, the ratchet 40 is adopted to provide the one-way clutch function and prevent the noise generated when the torsion spring is adopted, to separate the vibration generated by the rotating gear 30, and to prevent the vibration from being transferred from the first shaft 10 to the second shaft 20. Furthermore, the first shaft 10, the second shaft 20 and the ratchet 40 can be made by engineering plastic having the self-lubricating property, so that the friction, noise and vibration can be reduced, the service lifetime can be increased, and the cost can be decreased. In the operation test, the general standard test is based on the 100,000 paper feeds. With the one-way clutch assembly of this disclosure, the lifetime of 500,000 paper feeds can be achieved. Compared with the structure of FIG. 1, the cost of the one-way clutch assembly of this disclosure can be reduced by about 50%.

Optionally, the one-way clutch assembly 100 may further include a bushing 50, a buckle (or clip) 60, a first flange bearing 70 and a second flange bearing 80. The first shaft 10 is inserted into a small-diameter part 31 of the gear 30 and the small-diameter part 31 passes through the bushing 50, so that the bushing 50 rotatably mounts the gear 30 onto the body 210. The small-diameter part 31 ranges between the small-diameter part of the first shaft 10 (near the first end 11) and the bushing 50. So, compared with the condition where the bushing 50 is adopted to directly position the small-diameter part of the first shaft 10, using the bushing 50 in conjunction with the small-diameter part 31 to position the first shaft 10 can obtain the effect of effective utilizing the components and the firmer effect. In addition, the buckle 60 is snapped into a groove 16 on the first end 11 of the first shaft 10 to restrict an axial movement of the gear 30. The first flange bearing 70 and the second flange bearing 80 are mounted on the body 210. A middle-diameter part 14 of the first shaft 10 passes through the first flange bearing 70, the second end 22 of the second shaft 20 passes through the second flange bearing 80, and the first flange bearing 70 and the second flange bearing 80 restrict axial movements of the first shaft 10 and the second shaft 20.

In addition, a first end 21 of the second shaft 20 is fit with and rotatable relatively to a second end 12 of the first shaft 10. In one example, the first end 21 of the second shaft 20 is inserted into a hole 17 on the second end 12 of the first shaft 10, so that the relative rotation can be achieved, and the axial stability can be maintained. The ratchet 40 is rotatably disposed on the second end 12 of the first shaft 10 and the first end 21 of the second shaft 20, or the ratchet 40 is rotatably disposed on a fitting part between the second end 12 and the first end 21. The second end 12 and the first end 21 are disposed on an axis AL between the first end 11 and the second end 22. To achieve the one-way clutch function, a first ratchet part 43 of the ratchet 40 is rotatably fit with a second ratchet part 13 of the first shaft 10 to couple the first shaft 10 to the second shaft 20 in the unidirectional driving manner. Each of the first ratchet part 43 and the second ratchet part 13 includes a slow rising surface C and a steep descent surface F connected together. The steep descent surface F is used to achieve the power transmission, and the slow rising surface C is used to cut off the power transmission.

On the other hand, a first claw 44 of the ratchet 40 is rotatably fit with a second claw 24 of the second shaft 20 to a buffer interval or gap for the second shaft 20 to rotate the ratchet 40. The buffer interval may also be used to control the sheet-separation gap between the regular-size documents (e.g., the document with A4 or Letter sizes), the dynamic instability generated when the first ratchet part 43 is coupled to or decoupled from the second ratchet part 13 will not be immediately transferred to the second shaft 20, and the time point of starting to feed the next document can be buffered. In this example, each of the first claw 44 and the second claw 24 has two claw parts.

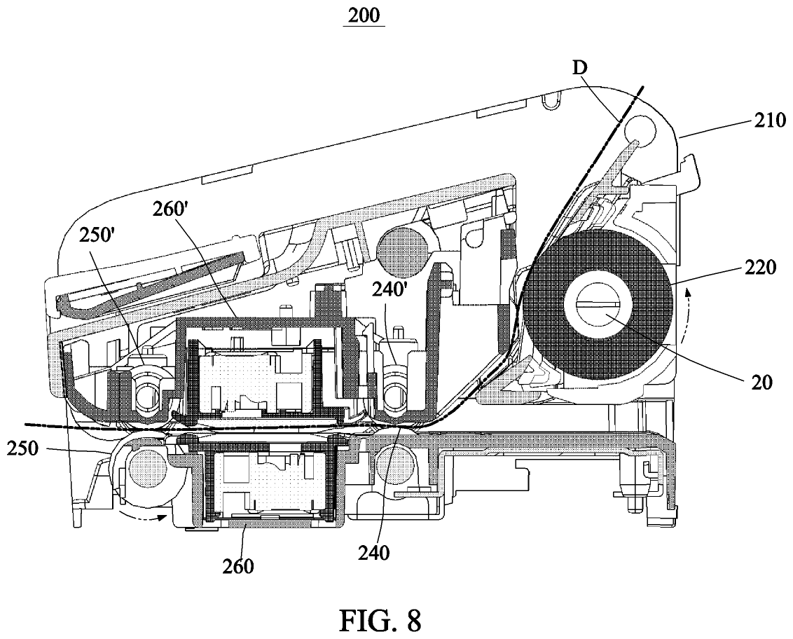

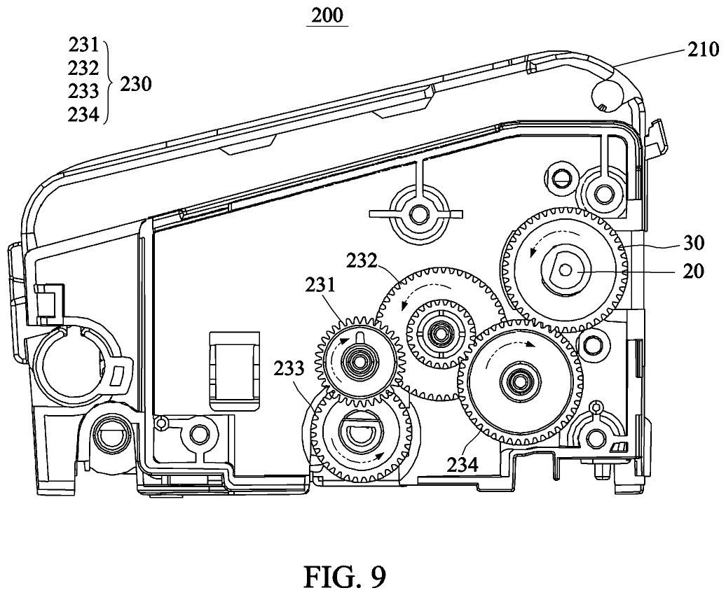

FIG. 8 is a schematically cross-sectional view showing inner members of the document scanner of FIG. 2. FIG. 9 is a schematic side view showing the document scanner of FIG. 2. Referring to FIGS. 8 and 9, the document scanner 200 further includes a driving gear set 230, a first roller 240, a second roller 250 and scanning modules 260 and 260′ (one single scanning module is also applicable). The driving gear set 230 includes gears 231, 232, 233 and 234. The driving gear set 230 drives the gear 30, the first roller 240 and the second roller 250 to rotate. The first roller 240 directly or indirectly drives a roller 240′ to rotate, and the second roller 250 directly or indirectly drives a roller 250′ to rotate.

The scanning modules 260 and 260′ are disposed between the first roller 240 and the second roller 250, wherein the feeding roller 220 transports a document D past the first roller 240, the scanning modules 260 and 260′ and the second roller 250 in order, and the scanning modules 260 and 260′ perform image acquiring operations on the document D passing through the scanning modules 260 and 260′. That is, a charge-coupled device (CCD) image sensor or a contact image sensor (CIS) is used to acquire the image of the document D.

In one example, a motor (not shown) drives the gear 231, the gear 231 drives the gears 232 and 233, the gear 232 drives the gear 234, and the gear 234 drives the gear 30. The gear 233 drives the first roller 240 and the second roller 250 to rotate, and the gear 30 drives the feeding roller 220 to rotate. When the motor rotates and the ratchet 40 is coupled to the power transmission, the first tangential velocity of the first roller 240 and second roller 250 for driving the document D is designed to be greater than the second tangential velocity of the feeding roller 220 for driving the document D. In the early stage of feeding the document D, when the document D is transported by the feeding roller 220 but does not touch the first roller 240, the ratchet 40 is coupled to the first shaft 10, and the first tangential velocity is greater than the second tangential velocity of the feeding roller 220. On the other hand, in the later stage of transporting the document D out, when the document D touches the first roller 240, the ratchet 40 is decoupled from the first shaft 10 (the power transmission is cut off), and the first tangential velocity of the first roller 240 and the second roller 250 is equal to the second tangential velocity of the feeding roller 220, so that the document D is not pulled and damaged. That is, the power coming from the second end 22 of the second shaft 20 cannot drive the first shaft 10 and the gear 30 to rotate. When the document D comes off the feeding roller 220 and is only transported by the first roller 240 and the second roller 250, another document (not shown) may have touched the feeding roller 220, and the first tangential velocity of the first roller 240 and the second roller 250 is greater than the second tangential velocity of the feeding roller 220, and the sheet-separation gap between the adjacent documents can be generated.

With the one-way clutch assembly of the above-mentioned embodiment, the engineering plastic can be used to manufacture most components with self-lubricating properties (exclusive of the buckle), so that the relative movements between these components cannot generate abnormal noise, these components can absorb vibration or cut off the vibration transfer, and the operation of the document scanner becomes quieter. In addition, the service lifetime can be effectively increased, and the cost can be effectively reduced.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A silent one-way clutch assembly, comprising:
a first shaft and a second shaft;
a gear mounted on a first end of the first shaft; and
a ratchet, which is rotatably disposed on a fitting part between a second end of the first shaft and a first end of the second shaft, and couples the first shaft to the second shaft in a unidirectional driving manner, so that the gear drives the second shaft to rotate through the first shaft and the ratchet, and stops power coming from a second end of the second shaft from driving the first shaft and the gear to rotate, wherein the second end of the first shaft and the first end of the second shaft are disposed on an axis between the first end of the first shaft and the second end of the second shaft.

2. The silent one-way clutch assembly according to claim 1, further comprising:
a bushing, wherein a small-diameter part of the gear passes through the bushing, so that the bushing rotatably mounts the gear to a body of a document scanner.

3. The silent one-way clutch assembly according to claim 1, further comprising:
a buckle snapped into a groove on the first end of the first shaft to restrict an axial movement of the gear.

4. The silent one-way clutch assembly according to claim 1, further comprising:
a first flange bearing and a second flange bearing mounted on a body of a document scanner, wherein the first shaft passes through the first flange bearing, the second shaft passes through the second flange bearing, and the first flange bearing and the second flange bearing restrict axial movements of the first shaft and the second shaft.

5. The silent one-way clutch assembly according to claim 1, wherein the first end of the second shaft is fit with and rotatable relatively to the second end of the first shaft.

6. The silent one-way clutch assembly according to claim 5, wherein a first ratchet part of the ratchet is rotatably fit with a second ratchet part of the first shaft to couple the first shaft to the second shaft in the unidirectional driving manner.

7. The silent one-way clutch assembly according to claim 6, wherein a first claw of the ratchet is rotatably fit with a second claw of the second shaft to provide a buffer interval for the second shaft to rotate the ratchet.

8. The silent one-way clutch assembly according to claim 5, wherein the first end of the second shaft is inserted into a hole on the second end of the first shaft.

9. A document scanner, comprising:
a body;
the silent one-way clutch assembly of claim 1 rotatably mounted on the body;
a feeding roller connected to the second shaft and driven by the second shaft to rotate;
a driving gear set driving the gear, a first roller and a second roller to rotate; and
a scanning module disposed between the first roller and the second roller, wherein the feeding roller transports a document past the first roller, the scanning module and the second roller in order, the scanning module performs an image acquiring operation on the document passing through the scanning module.

10. The document scanner according to claim 9, wherein:
when the document is transported by the feeding roller but does not touch the first roller, the ratchet is coupled to the first shaft, and a first tangential velocity of the first roller and the second roller is greater than a second tangential velocity of the feeding roller; and
when the document touches the first roller, the ratchet is decoupled from the first shaft, and the first tangential velocity of the first roller and the second roller is equal to the second tangential velocity of the feeding roller, so that a sheet-separation gap between the document and another adjacent document is formed.
